(19) United States
(12) Patent Application Publication
(10) Pub. No.: US 2024/0375770 A1
(43) Pub. Date: Nov. 14, 2024

(54) Scythe Wingtip Device

(71) Applicant: Textron Aviation Inc., Wichita, KS (US)

(72) Inventors: Kelly Ray Laflin, Andover, KS (US); Gonzalo Eduardo Mendoza, Wichita, KS (US); Corey Wailes Hagemeister, Wichita, KS (US)

(21) Appl. No.: 18/644,280

(22) Filed: Apr. 24, 2024

Related U.S. Application Data
(60) Provisional application No. 63/501,098, filed on May 9, 2023.

(51) Int. Cl. B64C 23/06

(52) U.S. Cl. CPC B64C 23/069

(57) ABSTRACT

Wingtip devices configured to extend from the outboard ends of aircraft wings are designed to effectively reduce induced drag, but they necessarily produce form and skin-friction drag, and they may produce interference and compressibility drag. The present disclosure describes a scythe-shaped wingtip device (or ‘winglet’ or ‘extending member’) suitable for reducing the induced drag of an aircraft wing while minimizing other types of drag. A cutout in the wingtip device reduces the wetted area of the wingtip to minimize non-induced drag while the wingtip device still reduces induced drag like a conventional wingtip device. The cutout is configured in a trailing edge of the wingtip device.

### CROSS-REFERENCE TO RELATED APPLICATIONS

This application claims the benefit of priority of U.S. Provisional Patent Application No. 63/501,098 entitled Scythe Wingtip Device, filed May 9, 2023, the disclosure of which is herein incorporated by reference in its entirety.

### BACKGROUND

### 1. Field

Embodiments of the invention relate generally to aircraft aerodynamics, and more specifically to wingtips and winglets for aircraft.

### 2. Related Art

Many different types of winglets and wingtips are known. Non-Patent Literature to Panagi, G. (2021) “Parametric study for optimizing winglet efficiency and comparative analysis of aerodynamic performance of a wing with no winglet and with different types of winglets for lighter aircraft”, Archive of Biomedical Science and Engineering Vol. 7, Issue 1: pp. 005-021, DOI: https://dx.doi.org/10.17352/abse.000024, discloses a modified winglet with a 60° cant angle having an intense curved back and winglets with sections cut out in semicircle shapes. For example, U.S. Patent Application Publication No. 2012/0312929 A1 to Gratzer discloses a split spiroid wing tip that may include a slight forward sweep to provide a tapered section. U.S. Patent Application Publication No. 2010/0163670 A1 to Dizdarevic et al. discloses a main wing trailing edge having a forward sweep. U.S. Patent Application Publication No. 2018/0105255 A1 to Blanco et al. discloses a trailing edge of the main wing having a continuous concavity that initially is projected toward the nose of the aircraft.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In embodiments of the present disclosure, a wingtip device includes: a wingtip leading edge configured to extend continuously with aft sweep outboard from a wing leading edge; and a wingtip trailing edge configured to extend continuously outboard of a wing trailing edge, wherein the wingtip trailing edge includes: a smooth continuation of the wing trailing edge at an interface between the wing and the wingtip device; and a cutout formed in the wingtip trailing edge, wherein the cutout extends outboard from the interface with forward sweep relative to the wing trailing edge.

In embodiments of the present disclosure, a device for reducing wing drag includes: an extending member that extends from an outboard interface of a wing to increase an effective span of the wing for reducing induced drag, wherein the extending member includes a leading edge and a trailing edge that each extend with a smooth and continuous profile from a wing leading edge and a wing trailing edge at the interface, respectively, wherein the trailing edge of the extending member curves forward of a planform projection of the wing trailing edge, thereby forming a reduction in wetted area of the extending member while maintaining a continuous profile with the wing trailing edge for reducing effects of skin-friction, form, interference, and compressibility drag.

In embodiments of the present disclosure, a winglet includes: an interface between a wing and the winglet wherein the interface includes one seamless structure; a winglet leading edge including a smooth and continuous profile at the interface with a wing leading edge; a winglet trailing edge including a smooth and continuous profile at the interface with a wing trailing edge; a tip configured aft of the trailing edge of the wing; and a cutout configured in the trailing edge of the winglet including an apex forward of a planform projection of the wing trailing edge, wherein the cutout reduces a wetted area of the winglet for reducing effects of skin-friction, form, interference, and compressibility drag.

### BRIEF DESCRIPTION OF THE DRAWING FIGURES

Embodiments of the invention are described in detail below with reference to the attached drawing figures, wherein:

FIG. 1 shows a wing planform ground projection illustrating the shape of a scythe wingtip device, in an embodiment;

FIG. 2A shows a wing planform ground projection illustrating another embodiment of a scythe wingtip device;

FIG. 2B shows a wing planform ground projection illustrating another embodiment of a scythe wingtip device;

FIG. 2C shows a wing planform ground projection illustrating another embodiment of a scythe wingtip device;

FIG. 2D shows a wing planform ground projection illustrating another embodiment of a scythe wingtip device;

FIG. 2E shows a wing planform ground projection illustrating another embodiment of a scythe wingtip device;

FIG. 2F shows a wing planform ground projection illustrating another embodiment of a scythe wingtip device;

FIG. 3A is a perspective view of the scythe wingtip device of FIG. 1;

FIG. 3B is a top-down view of the scythe wingtip device of FIG. 1;

FIG. 3C is a front view the scythe wingtip device of FIG. 1;

FIG. 3D is a side view the scythe wingtip device of FIG. 1;

FIG. 4A is a perspective view of an upturned scythe winglet, in an embodiment;

FIG. 4B is a top-down view of the upturned scythe winglet of FIG. 4A;

FIG. 4C is a front view of the upturned scythe winglet of FIG. 4A;

FIG. 4D is a side view of the upturned scythe winglet of FIG. 4A;

FIG. 5A is a perspective view of a downturned scythe winglet, in an embodiment;

FIG. 5B is a top-down view of the downturned scythe winglet of FIG. 5A;

FIG. 5C is a front view of the downturned scythe winglet of FIG. 5A;

FIG. 5D is a side view of the downturned scythe winglet of FIG. 5A;

FIG. 6A shows a scythe wingtip having continuous and smooth spanwise thickness, in an embodiment;

FIG. 6B shows another scythe wingtip having continuous and smooth spanwise thickness, in an embodiment;

FIG. 6C shows yet another scythe wingtip having continuous and smooth spanwise thickness, in an embodiment;

FIG. 7A shows a scythe wingtip having a first span;

FIG. 7B shows a scythe wingtip having a second span shorter than the first span;

FIG. 7C shows a scythe wingtip having a third span shorter than each of the first and second spans;

FIG. 8A shows a scythe wingtip having a first cutout;

FIG. 8B shows a scythe wingtip having a second cutout shallower than the first cutout;

FIG. 8C shows a scythe wingtip having a third cutout shallower than each of the first and second cutouts;

FIG. 9A shows a scythe wingtip having a first distance of a cutout apex from the wing interface;

FIG. 9B shows a scythe wingtip having a second distance of the cutout apex from the wing interface that is greater than the first distance;

FIG. 9C shows a scythe wingtip having a third distance of the cutout apex from the wing interface that is greater than each of the first and second distances;

FIG. 10A shows a scythe wingtip having a first tip angle at the trailing edge;

FIG. 10B shows a scythe wingtip having a second tip angle at the trailing edge that is larger than the first tip angle;

FIG. 10C shows a scythe wingtip having a third tip angle at the trailing edge that is larger than each of the first and second tip angles;

FIG. 10D shows a scythe wingtip having a fourth tip angle at the trailing edge that is larger than each of the first, second, and third tip angles;

FIG. 11A shows a scythe wingtip having a first shape of a leading edge;

FIG. 11B shows a scythe wingtip having a second shape of the leading edge that sweeps aft more than the first shape;

FIG. 11C shows a scythe wingtip having a third shape of the leading edge that sweeps aft more than each of the first and second shapes;

FIG. 12A shows a scythe wingtip having an outboard edge of a first length;

FIG. 12B shows a scythe wingtip having an outboard edge of a second length that is greater than the first length;

FIG. 12C shows a scythe wingtip having an outboard edge of a third length that is greater than each of the first and second lengths;

FIG. 13A shows a scythe wingtip having a first outboard edge angle;

FIG. 13B shows a scythe wingtip having a second outboard edge angle that is smaller than the first outboard edge angle;

FIG. 13C shows a scythe wingtip having a third outboard edge angle that is less than each of the first and second outboard edge angles;

FIG. 14A shows a scythe wingtip having a first leading edge shape;

FIG. 14B shows a scythe wingtip having a second leading edge shape that is different from the first leading edge shape;

FIG. 14C shows a scythe wingtip having a third leading edge shape that is different from each of the first and second leading edge shapes;

FIG. 15A shows a scythe wingtip having a first trailing edge shape;

FIG. 15B shows a scythe wingtip having a second trailing edge shape that is different from the first trailing edge shape; and

FIG. 15C shows a scythe wingtip having a third trailing edge shape that is different from each of the first and second trailing edge shapes.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Reductions in drag can have a substantial positive change in aircraft performance, fuel burn, overfly noise, and emissions. A significant contribution of the overall drag of an aircraft arises from lift generation and is commonly referred to as “induced drag”. Induced drag is a characteristic of all wings of finite span and is dependent on how the wing lifting force is distributed. The amount of induced drag produced by a wing can be affected by altering its lift distribution through twist, airfoil design, and/or wing planform changes. A popular, practical, and effective way to reduce induced drag is to change the wing planform by adding a wingtip device. Wingtip devices can be in-plane with the wing, such as wingtip extensions and raked wingtips, or out-of-plane, such as winglets and end plates. One example of an in-plane wingtip extension is a curved planar wingtip described in U.S. Pat. No. 11,148,788 to Swanson, which is hereby incorporated by reference in its entirety.

Although wingtip devices can effectively reduce induced drag, they necessarily produce form and skin-friction drag, and they may produce interference and compressibility drag. Prior art wingtip devices aim to reduce induced drag without simultaneously reducing the negative effects of skin-friction, form, interference, and compressibility drag. Increased form drag production is related to the increase in projected frontal area resulting from the wingtip device, and increased skin-friction, or viscous, drag is associated with its increased wetted area. Interference drag is associated with the aerodynamic incompatibility of the wing-wingtip device interface, often resulting from large, localized spanwise pressure gradients. At transonic and higher speeds, compressibility effects may lead to compressibility or wave drag. Buffet and flutter are often driven by the same fluid-dynamic mechanisms responsible for interference and wave drag. Embodiments disclosed herein provide reductions in induced drag in a practical manner, while lessening the effect on form, skin-friction, interference, and wave drag compared to prior art wingtip devices. For the purposes of this description, a wingtip device may be referred to as a winglet, an extending member, or a wingtip device, wherein each item comprises a portion at the outboard end of a wing comprising a wingtip and increasing the effective wingspan of the wing, wherein the wingspan is the distance from the most inboard end to the most outboard end of the wing.

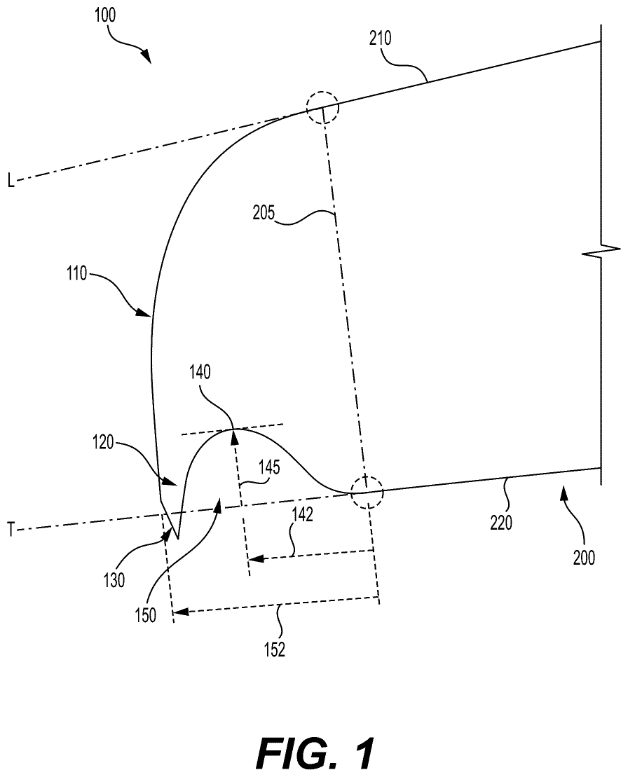

FIG. 1 shows a scythe wingtip 100 extending from a wing 200. Specifically, FIG. 1 shows a wing planform ground projection illustrating the shape of scythe wingtip 100 as it extends from an outboard portion of wing 200. Wing 200 comprises a wing leading edge 210 and a wing trailing edge 220. Likewise, scythe wingtip 100 comprises a leading edge 110 that extends from wing leading edge 210 and a trailing edge 120 that extends from wing trailing edge 220. A tip 130 is formed between leading edge 110 and trailing edge 120 such that leading edge 110 and trailing edge 120 may meet at tip 130. In some but not all embodiments, tip 130 is the most outboard portion of scythe wingtip 100, or the literal wingtip. An interface 205 between scythe wingtip 100 and wing 200 indicates the end of wing 200 and the beginning of scythe wingtip 100.

In some embodiments, interface 205 is an actual physical interface formed when scythe wingtip 100 is added to wing 200; for example, wing 200 may lack a wingtip device or have a different style of wingtip/winglet and subsequently be retrofitted with scythe wingtip 100. For an added wingtip, structural connections are made between the outboard end of wing 200 (e.g., via wing spars) and the inboard edge of scythe wingtip 100 for securing the two together. Alternatively, scythe wingtip 100 and wing 200 may be formed together during new construction of an aircraft as one seamless structure; in this case, interface 205 represents a projected planform between where wing leading edge 210 begins to transition to leading edge 110 and where wing trailing edge 220 begins to transition to trailing edge 120, as shown in FIG. 1. In embodiments, scythe wingtip 100 shares with wing 200 a common cross-sectional airfoil profile at interface 205, including a common chord length and a common twist (not shown).

In embodiments, leading edge 110 extends continuously from wing leading edge 210 such that leading edge 110 and wing leading edge 210 have a matching slope at interface 205, thereby making leading edge 110 have a smooth and continuous profile in the mathematical sense with wing leading edge 210 at interface 205. Subsequent geometries described herein as “smooth” and/or “continuous” imply a similar definition unless otherwise noted. Leading edge 110 is configured as a continuation of wing leading edge 210 at interface 205 and extends outboard with aft sweep. Leading edge 110 may comprise a combination of linear and curvilinear segments. A dashed line labeled “L” in FIG. 1 represents a projected planform aligned with and extending from wing leading edge 210.

Trailing edge 120 may also comprise a combination of linear and curvilinear segments. A dashed line labeled “T” in FIG. 1 represents a projected planform aligned with and extending from wing trailing edge 220. Trailing edge 120 extends outboard of the wing and comprises the following characteristics: 1) a smooth and continuous extension of wing trailing edge 220 at interface 205; 2) an inboard section having forward sweep relative to projected planform T extending from wing trailing edge 220; and 3) an apex 140 located an apex distance 142 outboard of interface 205. In some embodiments, trailing edge 120 comprises an outboard section (i.e., outboard of apex 140) that has aft sweep relative to wing trailing edge 220; however, in other embodiments, trailing edge 120 may have little or no aft sweep outboard of apex 140.

The forward sweep portion of trailing edge 120 forms a cutout 150 in the planform of scythe wingtip 100 along its trailing edge. Apex 140 is located between a forward swept inboard section and an aft swept outboard section of trailing edge 120 and represents an apex of cutout 150, which is the forward most point or segment of trailing edge 120. Apex 140 is located a forward distance 145 from planform T as indicated in FIG. 1, wherein forward distance 145 is normal to planform T. In embodiments, a projected planform tangent to trailing edge 120 at apex 140 has identical slope with projected planform T. A span 152 represents a spanwise width of scythe wingtip 100 from interface 205 to an outermost portion of leading edge 110. Generally, in reference to the present description, a span 152 of a winglet, wingtip device, or extending member comprises a distance from an interface 205 to a most outboard point of the winglet, wingtip device, or extending member.

In the FIG. 1 embodiment, forward distance 145 is less than apex distance 142, while apex distance 142 is greater than half of span 152, and tip 130 extends aft of projected planform T (e.g., aft of wing trailing edge 220). Span 152 of scythe wingtip 100 is less than the length of the chord of wing 200 at its outboard end (i.e., along interface 205).

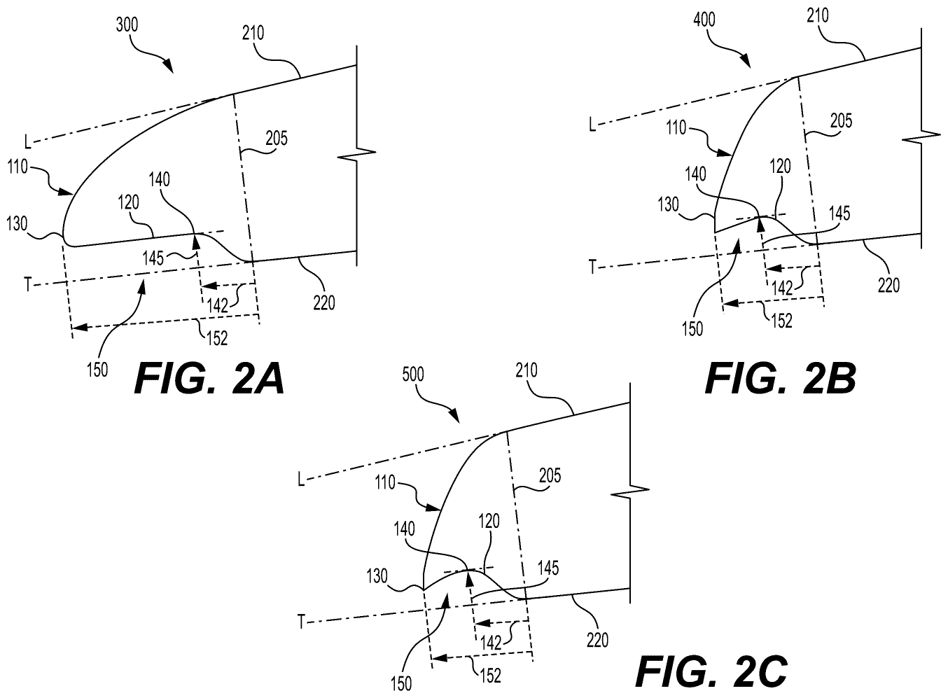

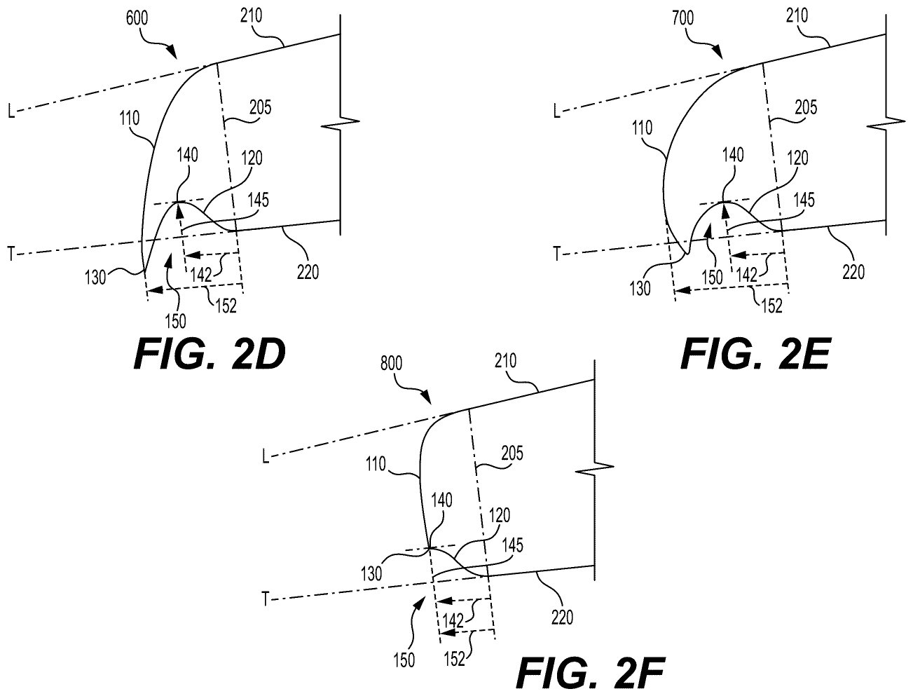

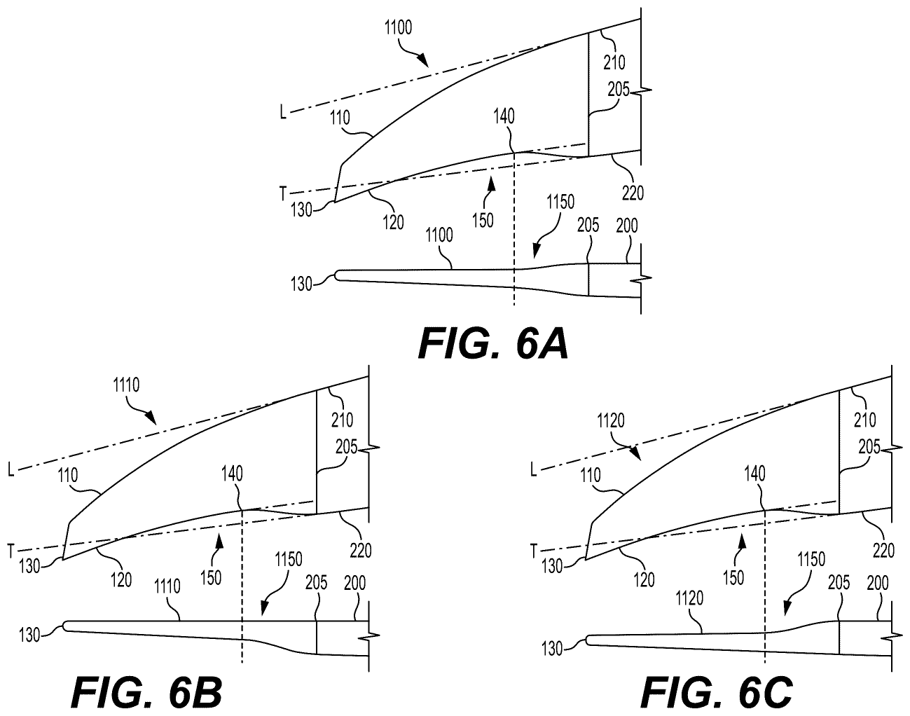

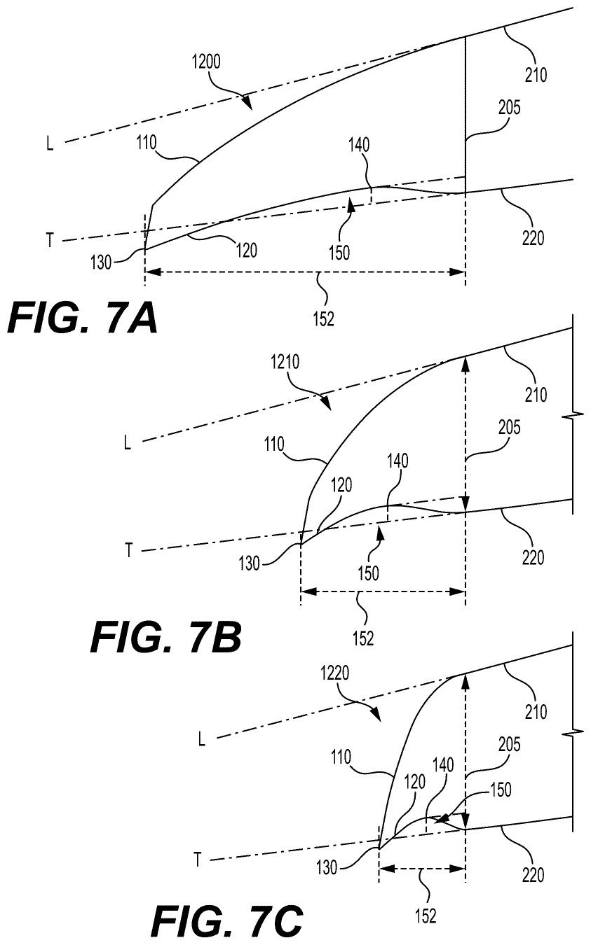

Tip 130 may comprise a pointed, sheared, or, rounded shape, or another shape as required or desired for a particular application (e.g., see FIGS. 2A-2E). Both spanwise, chord and thickness distributions of scythe wingtip 100 are substantially smooth and continuous distributions. FIGS. 6A-6C, described below, show examples of continuous thickness distributions. However, in embodiments, discrete discontinuities may be provided to allow for mechanical constraints such as installation hardware, inspection access, anti-ice bleed air exhaust, fuel jettison, lights, or other aircraft subsystems without departing from the scope hereof. Specific planform dimensions (i.e., span, leading and trailing edge sweep angles, leading and trailing edge shapes, tip shapes, outboard edge angles and lengths) adhere to the preceding description but may vary depending on specific applications (see FIGS. 7A to 15C). Airfoil cross-sectional shape (see FIGS. 6A to 6C) and twist distributions are also application specific (e.g., depending on the shape of wing 200 and other aircraft considerations including light installations). In embodiments, scythe wingtip 100 may be configured in-plane with wing 200, or out-of-plane with the wing 200 as a winglet, without departing from the scope hereof.

The term “scythe” as used herein refers to a general resemblance between the shape of the wingtip (e.g., from a top-down view) and the curved blade of a tool used for cutting crops known as a scythe. For example, the curvature of trailing edge 120, the forward sweep of trailing edge 120 as it extends from wing trailing edge 220 thereby forming cutout 150, and the pointed tip 130 extending from the long sweeping curvature of leading edge 110 together provide the distinctive shape of scythe wingtip 100.

The shape of trailing edge 120, with cutout 150, effectively removes wetted area from the wingtip and provides a reduced equivalent frontal area while continuously extending the lifting line of the wing. These features enable a reduction in induced drag to be realized, while simultaneously reducing the amount of additional form and skin-friction drag as compared to prior wingtip devices. Furthermore, the continuity of surface contour at the interface 205 reduces the potential for interference drag and provides a practical configuration for attachment of scythe wingtip 100 to wing 200.

FIGS. 2A-2F each show a wing planform ground projection that illustrates an embodiment of a scythe wingtip as it extends from an outboard portion of wing 200. Each of scythe wingtips 300, 400, 500, 600, 700, and 800 are examples of scythe wingtip 100 having various shapes and distortions compared to scythe wingtip 100 as further described below. Items enumerated with like numerals between the figures represent the same or similar features and their descriptions may not be repeated accordingly.

FIG. 2A shows a scythe wingtip 300 having trailing edge 120 with forward sweep from interface 205 to apex 140, thereby forming cutout 150. Scythe wingtip 300 is characterized by trailing edge 120 extending from apex 140 to tip 130 in a direction parallel with wing trailing edge 220 rather having aft sweep relative to wing trailing edge 220 as with scythe wingtip 100. In the FIG. 2A embodiment, forward distance 145 is less than apex distance 142, while apex distance 142 is less than half of span 152, and tip 130 does not extend aft of projected planform T. Tip 130 is substantially rounded and approximately the same distance from interface 205 as span 152. Span 152 of scythe wingtip 300 is greater than the length of the chord of wing 200 at its outboard end (i.e., along interface 205).

FIG. 2B shows a scythe wingtip 400 having trailing edge 120 with forward sweep from interface 205 to apex 140, thereby forming cutout 150. Scythe wingtip 400 is characterized by trailing edge 120 extending from apex 140 to tip 130 in a substantially straight line with aft sweep relative to wing trailing edge 220 but with tip 130 remaining forward of projected planform T. In the FIG. 2B embodiment, forward distance 145 is less than apex distance 142, while apex distance 142 is approximately half of span 152, and tip 130 does not extend aft of projected planform T. Tip 130 is substantially pointed and approximately the same distance from interface 205 as span 152. Span 152 of scythe wingtip 400 is less than the length of the chord of wing 200 at its outboard end (i.e., along interface 205).

FIG. 2C shows a scythe wingtip 500 having trailing edge 120 with forward sweep from interface 205 to apex 140, thereby forming cutout 150. Scythe wingtip 500 is characterized by trailing edge 120 curving substantially from apex 140 to tip 130 with aft sweep but with tip 130 remaining forward of projected planform T. In the FIG. 2C embodiment, forward distance 145 is less than apex distance 142, while apex distance 142 is less than half of span 152, and tip 130 does not extend aft of projected planform T. Tip 130 is substantially pointed and approximately the same distance from interface 205 as span 152. Span 152 of scythe wingtip 500 is less than the length of the chord of wing 200 at its outboard end (i.e., along interface 205).

FIG. 2D shows a scythe wingtip 600 having trailing edge 120 with forward sweep from interface 205 to apex 140, thereby forming cutout 150. Scythe wingtip 600 is characterized by trailing edge 120 curving from apex 140 to tip 130 with aggressive aft sweep and with tip 130 extending substantially aft of projected planform T. In the FIG. 2D embodiment, forward distance 145 is less than apex distance 142, while apex distance 142 is more than half of span 152, and tip 130 extends substantially aft of projected planform T. Tip 130 is substantially pointed and approximately the same distance from interface 205 as span 152. Span 152 of scythe wingtip 600 is less than the length of the chord of wing 200 at its outboard end (i.e., along interface 205).

FIG. 2E shows a scythe wingtip 700 having trailing edge 120 with forward sweep from interface 205 to apex 140, thereby forming cutout 150. Scythe wingtip 700 is characterized by trailing edge 120 curving smoothly aft to tip 130, with tip 130 extending substantially aft of projected planform T. In the FIG. 2E embodiment, forward distance 145 is less than apex distance 142, while apex distance 142 is approximately half of span 152. Leading edge 110 curves inboard towards tip 130 such that a distance between tip 130 and interface 205 is substantially less than span 152. Thus, in this embodiment and similar embodiments, tip 130 is not the literal wingtip. Tip 130 is substantially rounded. Span 152 of scythe wingtip 700 is less than the length of the chord of wing 200 at its outboard end (i.e., along interface 205).

FIG. 2F shows a scythe wingtip 800 having trailing edge 120 with forward sweep from interface 205 to apex 140, thereby forming cutout 150. Scythe wingtip 800 is characterized by apex 140 being positioned at or near tip 130 such that trailing edge 120 lacks any aft sweep and tip 130 remains forward of projected planform T. In the FIG. 2F embodiment, forward distance 145 is less than apex distance 142, while apex distance 142 is substantially the same as span 152. Span 152 of scythe wingtip 800 is less than the length of the chord of wing 200 at its outboard end (i.e., along interface 205).

Note that with all of scythe wingtips 100, 300, 400, 500, 600, 700, and 800, trailing edge 220 has a substantially smooth and continuous profile comprising a combination of linear and curvilinear segments that lacks any discontinuities or abrupt angles. However, in embodiments, discrete discontinuities may be provided to allow for mechanical constraints such as installation hardware, inspection access, anti-ice bleed air exhaust, fuel jettison, lights, or other aircraft subsystems without departing from the scope hereof. For scythe wingtips 300, 400, 500, and 800, tip 130 is forward of projected planform T while tip 130 is aft of projected planform T for scythe wingtips 600 and 700.

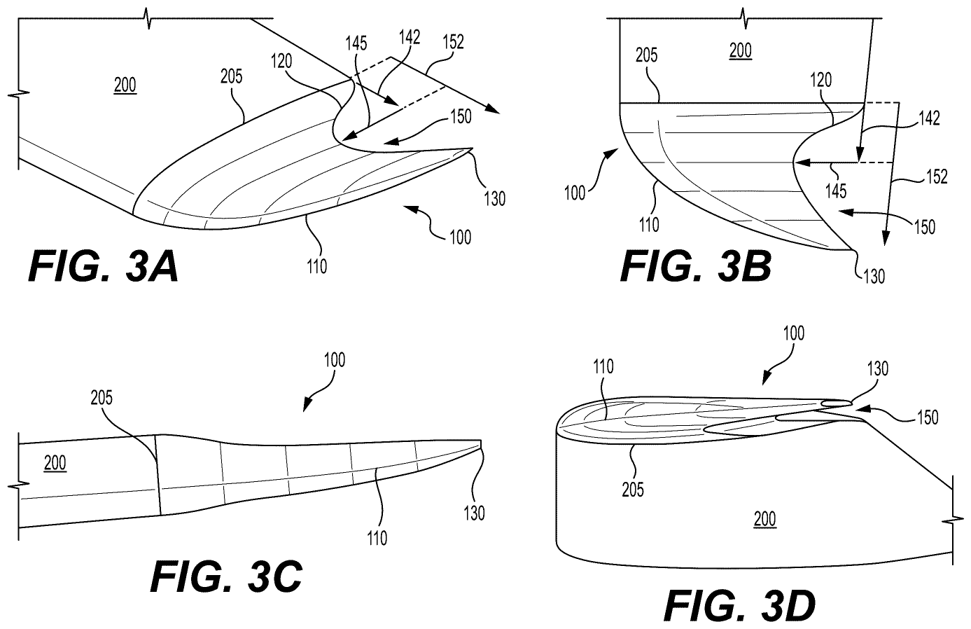

FIGS. 3A-3D each show scythe wingtip 100 extending from wing 200. Items enumerated with like numerals between the figures represent the same or similar features and their descriptions may not be repeated accordingly. FIG. 3A is a perspective view of scythe wingtip 100 showing forward sweep of trailing edge 120 outboard from interface 205 thereby forming cutout 150. FIG. 3B is a top-down view of scythe wingtip 100 showing forward sweep of trailing edge 120 outboard from interface 205 thereby forming cutout 150. In FIGS. 3A and 3B, apex distance 142 is less than forward distance 145. FIG. 3C is a front view showing the profile of scythe wingtip 100 and the in-plane configuration of scythe wingtip 100 with respect to wing 200. FIG. 3D is a side view showing an outboard side of scythe wingtip 100 and the in-plane configuration.

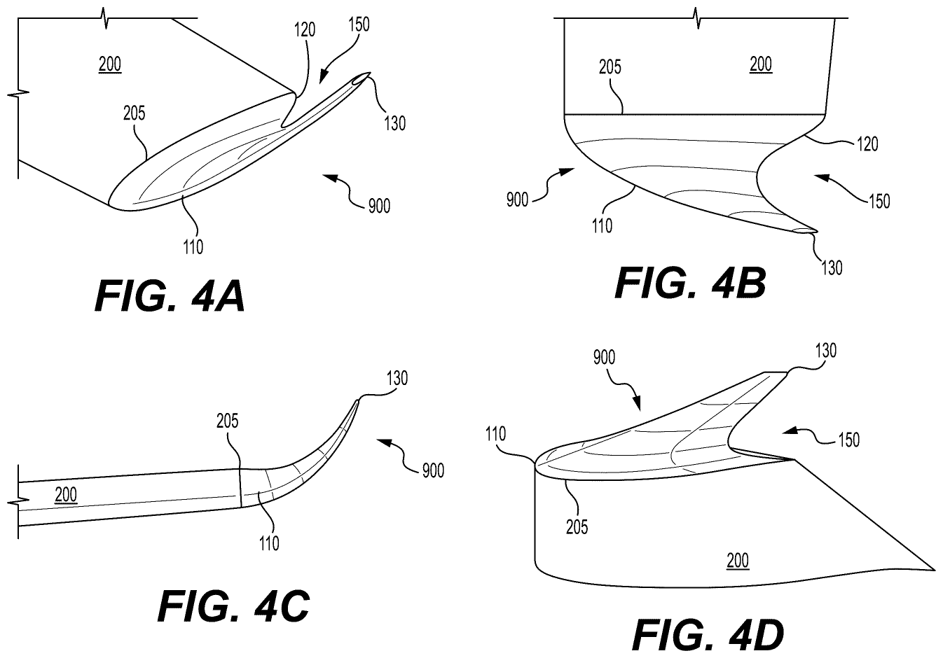

FIGS. 4A-4D each show an upturned scythe winglet 900 extending from wing 200. Upturned scythe winglet 900 is an example of scythe wingtip 100 having upward curvature with tip 130 extending substantially above the plane of wing 200. Items enumerated with like numerals between the figures represent the same or similar features and their descriptions may not be repeated accordingly. FIG. 4A is a perspective view of upturned scythe winglet 900 showing forward sweep of trailing edge 120 outboard from interface 205 thereby forming cutout 150. FIG. 4B is a top-down view of upturned scythe winglet 900 showing forward sweep of trailing edge 120 outboard from interface 205 thereby forming cutout 150. FIG. 4C is a front view showing the profile of upturned scythe winglet 900 and the bending of upturned scythe winglet 900 upwards with tip 130 substantially above the plane of wing 200. FIG. 4D is a side view showing an outboard side of upturned scythe winglet 900 and the upwards bending of upturned scythe winglet 900.

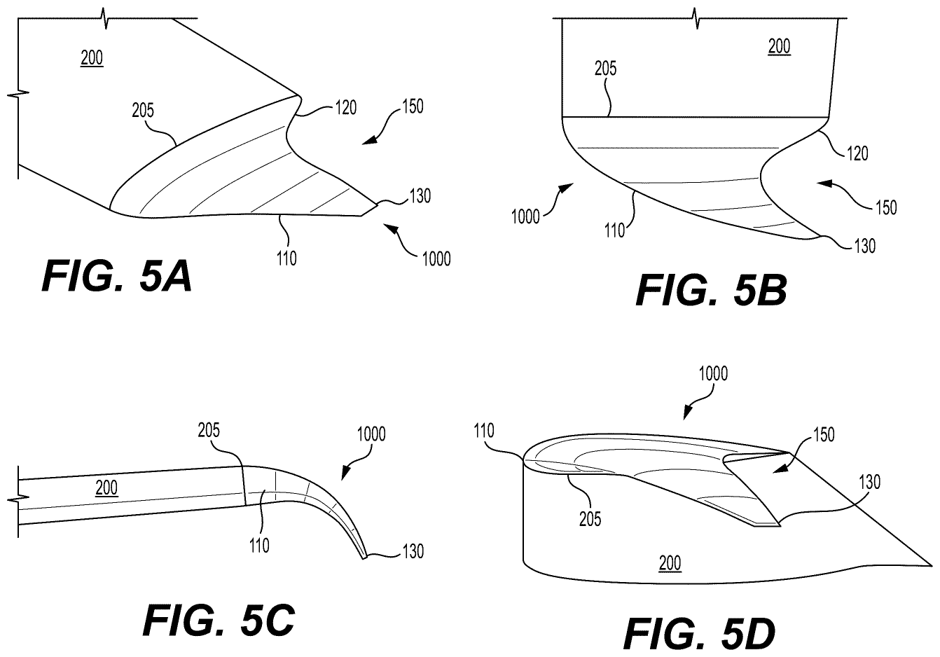

FIGS. 5A-5D each show a downturned scythe winglet 1000 extending from wing 200. Downturned scythe winglet 1000 is an example of upturned scythe winglet 900 having downward curvature with tip 130 extending substantially below the plane of wing 200. Items enumerated with like numerals between the figures represent the same or similar features and their descriptions may not be repeated accordingly. FIG. 5A is a perspective view of downturned scythe winglet 1000 showing forward sweep of trailing edge 120 outboard from interface 205 thereby forming cutout 150. FIG. 5B is a top-down view of downturned scythe winglet 1000 showing forward sweep of trailing edge 120 outboard from interface 205 thereby forming cutout 150. FIG. 5C is a front view showing the profile of downturned scythe winglet 1000 and the bending of downturned scythe winglet 1000 downwards with tip 130 substantially beneath the plane of wing 200. FIG. 5D is a side view showing an outboard side of downturned scythe winglet 1000 and the downwards bending of downturned scythe winglet 1000.

FIGS. 6A to 15C each show a wing planform ground projection that illustrates an embodiment of a scythe wingtip as it extends from an outboard portion of wing 200. Items enumerated with like numerals between the figures represent the same or similar features and their descriptions may not be repeated accordingly.

FIGS. 6A-6C show some non-limiting examples of wingtips having continuous and smooth (but not necessarily uniform) spanwise thickness. Specifically, FIGS. 6A-6C each show a top view aligned with a front view of an example wingtip. In embodiments, a spanwise thickness of the scythe wingtip narrows from the interface 205 with wing 200 towards tip 130 linearly according to a constant slope on both top and bottom surfaces (not shown). Alternatively, a non-linear narrowing portion 1150 may be provided in which a portion of the spanwise thickness narrows more rapidly compared to other portions of the wingtip. FIGS. 6A-6C show exemplary scythe wingtips 1100, 1110, 1120 having a continuous and smooth spanwise thickness (i.e., lacking discontinuities or abrupt transitions) in which the thickness of scythe wingtip 1100, 1110, 1120 narrows from the interface 205 with wing 200 towards the tip 130. Each of scythe wingtips 1100, 1110, 1120 include non-linear narrowing portion 1150 in which the spanwise thickness narrows more rapidly compared with other (e.g., outboard) portions of the wingtip. For example, as shown in FIGS. 6A-6C, wingtips 1100, 1110, 1120, each narrow linearly according to a constant slope from non-linear narrowing portion 1150 outboard towards tip 130. For example, as shown in FIG. 6A, non-linear narrowing portion 1150 of scythe wingtip 1100 includes non-linear narrowing of both the top and bottom surfaces; as shown in FIG. 6B, non-linear narrowing portion 1150 of scythe wingtip 1110 includes non-linear narrowing of only the bottom surface; and, as shown in FIG. 6C, non-linear narrowing portion 1150 of scythe wingtip 1120 includes non-linear narrowing of only the top surface. Other variations of spanwise thickness are possible without departing from the scope hereof; however, any variations in spanwise thickness include smooth and continuous transitions that lack discontinuities or abrupt transitions.

FIGS. 7A-7C show some non-limiting examples of wingtips having variations in span. For example, as shown in FIG. 7A, a scythe wingtip 1200 has a long span 152 in which the span 152 is greater than the length of the chord of wing 200 at its outboard end (i.e., along interface 205); as shown in FIG. 7B, a scythe wingtip 1210 has a medium span 152 in which the span 152 is substantially the same as the chord of wing 200 along interface 205; and, as shown in FIG. 7C, a scythe wingtip 1220 has a short span 152 in which the span 152 is less than the chord of wing 200 along interface 205.

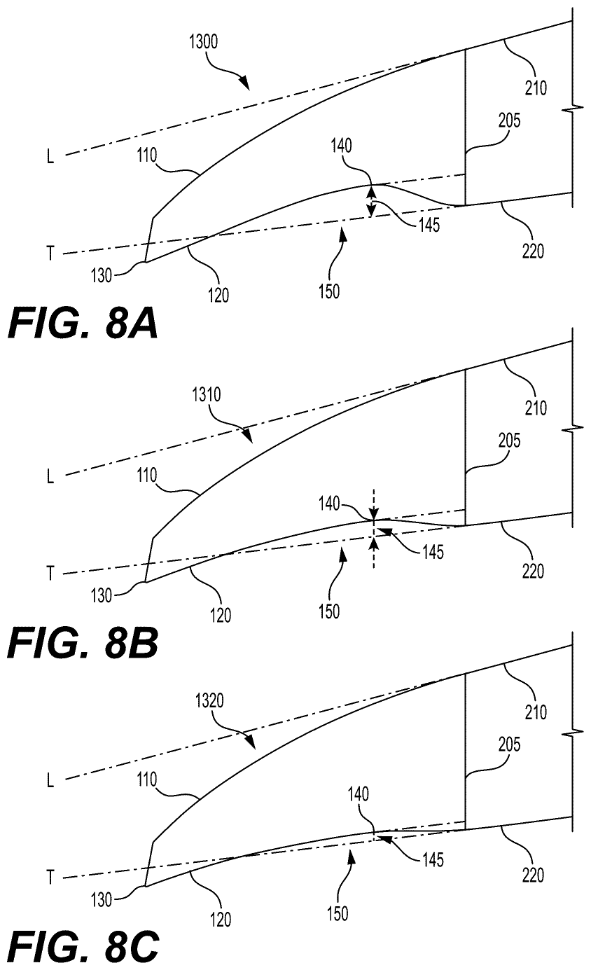

FIGS. 8A-8C show some non-limiting examples of wingtips having variations in a depth of cutout 150 (i.e., variations in the size of forward distance 145 from projected planform T to apex 140). For example, as shown in FIG. 8A, a scythe wingtip 1300 has a deep cutout 150 in which the forward distance 145 is the largest among wingtips 1300, 1310, and 1320; as shown in FIG. 8B, a scythe wingtip 1310 has a medium cutout 150 in which the forward distance 145 is less than that of scythe wingtip 1300 but greater than that of a scythe wingtip 1320; and, as shown in FIG. 8C, scythe wingtip 1320 has a shallow cutout 150 in which the forward distance 145 is less than that of scythe wingtip 1310.

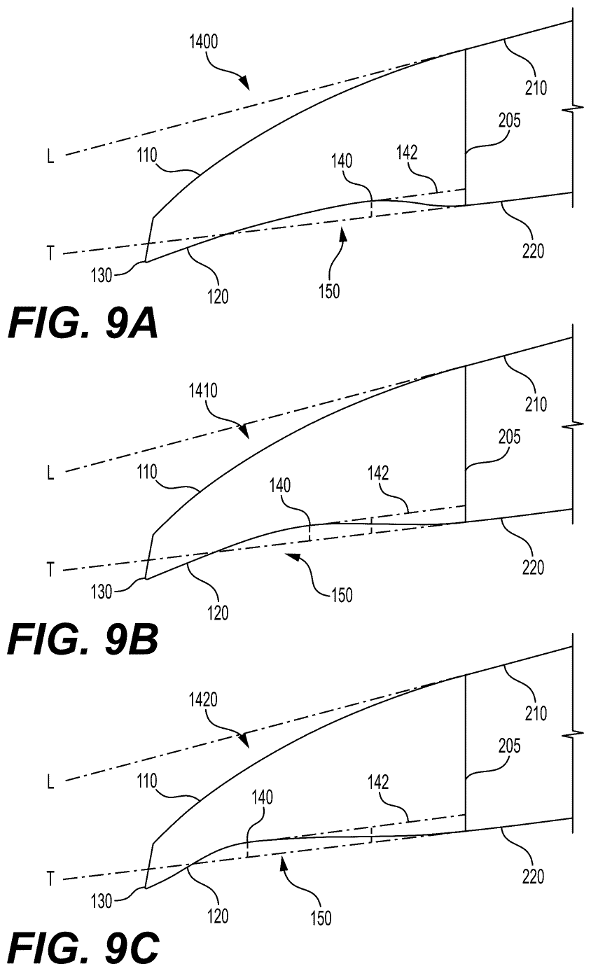

FIGS. 9A-9C show some non-limiting examples of wingtips having variations in the apex distance 142 of apex 140 from interface 205. For example, as shown in FIG. 9A, a scythe wingtip 1400 has a short apex distance 142 in which the spanwise distance of apex 140 from interface 205 is the shortest among wingtips 1400, 1410, and 1420; as shown in FIG. 9B, a scythe wingtip 1410 has a medium apex distance 142 in which the spanwise distance of apex 140 from interface 205 is less than that of scythe wingtip 1400 but greater than that of a scythe wingtip 1420; and, as shown in FIG. 8C, scythe wingtip 1420 has a long apex distance 142 in which the spanwise distance of apex 140 from interface 205 is greater than that of scythe wingtips 1410 and 1400.

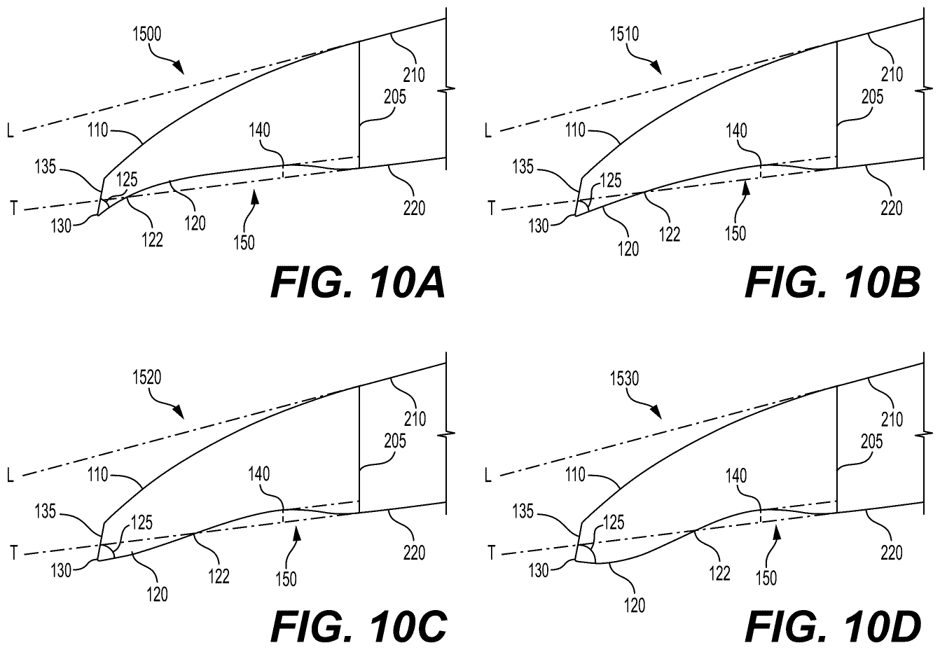

FIGS. 10A-10D show some non-limiting examples of wingtips having variations in tip angle at the trailing edge. For example, scythe wingtips 1500, 1510, 1520, and 1530 of FIGS. 10A, 10B, 10C, and 10D, respectively, have varying shape of trailing edge 120 between apex 140 and tip 130 such that a tip angle 125 between trailing edge 120 and an outboard edge 135 of the wingtip varies in size. In embodiments, different tip angles 125 may lead to different tip 130 shapes, such as a pointed, sheared, or rounded tip 130. For example, as shown in FIG. 10A, a scythe wingtip 1500 has the narrowest tip angle 125 among wingtips 1500, 1510, 1520, and 1530; as shown in FIG. 10B, a scythe wingtip 1510 has a wider tip angle 125 compared to that of wingtip 1500; as shown in FIG. 10C, a scythe wingtip 1520 has a wider tip angle 125 compared to that of wingtips 1500 and 1510; and, as shown in FIG. 10D, a scythe wingtip 1530 has the widest tip angle 125 among wingtips 1500, 1510, 1520, and 1530.

In addition to wingtips 1500, 1510, 1520, and 1530 having varying tip angles 125, the varying shape of trailing edge 120 between apex 140 and tip 130 also affects the shape and spanwise width of cutout 150. An intersection 122 is defined herein as the spanwise position at which trailing edge 120 intersects projected planform T as shown in FIGS. 10A-10D. In other words, intersection 122 is the outboard position where cutout 150 effectively ends as trailing edge 120 crosses from forward of projected planform T to aft of projected planform T. For example, as shown in FIG. 10A, intersection 122 is furthest outboard on scythe wingtip 1500 compared to wingtips 1510, 1520, and 1530; as shown in FIG. 10B, intersection 122 is further inboard on scythe wingtip 1510 compared to that of wingtip 1500 but further outboard compared to wingtips 1520 and 1530; as shown in FIG. 10C, intersection 122 is further inboard on scythe wingtip 1520 compared to that of wingtips 1500 and 1510 but further outboard compared to wingtip 1530; and, as shown in FIG. 10D, intersection 122 is furthest inboard on scythe wingtip 1530 compared to wingtips 1500, 1510, and 1520. The trailing edge 120 of wingtips 1500 and 1510 each curve continuously aft from apex 140 to tip 130; in contrast, the trailing edge 120 of wingtips 1520 and 1530 each have an inflection point in aft curvature of trailing edge 120. Trailing edge 120 of wingtip 1530 transitions from curving aft to curving forward such that a portion of trailing edge 120 is aft of tip 130; in contrast, tip 130 is the aftmost portion of each of wingtips 1500, 1510, and 1520.

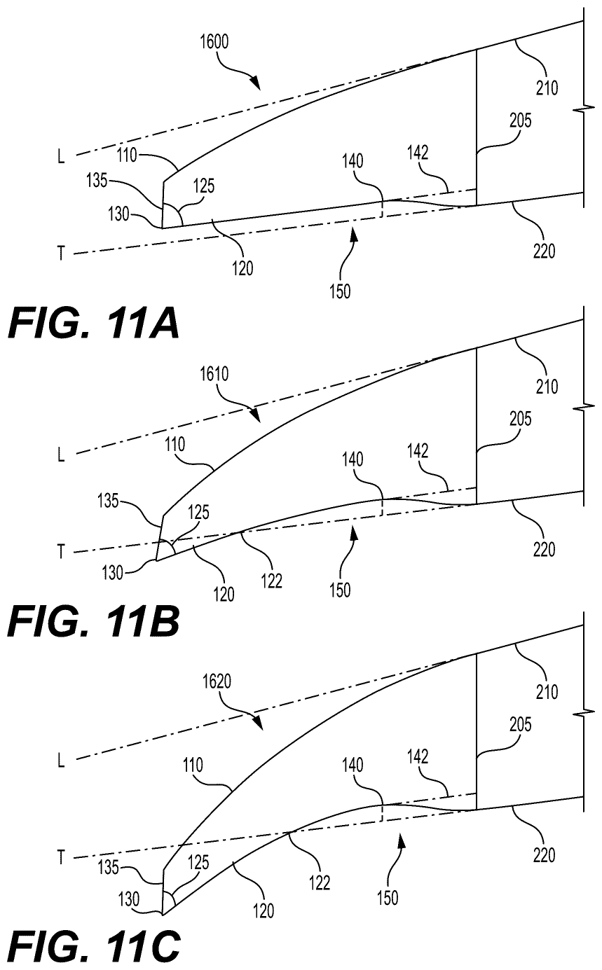

FIGS. 11A-11C show some non-limiting examples of wingtips having variations in leading edge sweep. For example, scythe wingtips 1600, 1610, and 1620 of FIGS. 11A, 11B, and 11C, respectively, each have leading edges 110 that sweep aft of projected planform L by varying amounts. For example, as shown in FIG. 11A, a scythe wingtip 1600 has a small aft sweep of leading edge 110 in which the entire outboard edge 135 is forward of projected planform T; as shown in FIG. 11B, a scythe wingtip 1610 has a medium aft sweep of leading edge 110 in which outboard edge 135 straddles projected planform T (i.e., the outboard end of leading edge 110 if forward of planform T, while tip 130 is aft of planform T); and, as shown in FIG. 11C, scythe wingtip 1620 has a large aft sweep of leading edge 110 in which the entire outboard edge 135 is aft of projected planform T. Note how the leading edge sweep variations also affect the tip angle 125, the aft sweep of trailing edge 120, and the forward/aft position of tip 130. In other words, greater sweep angles of leading edge 110 cause tip 130 to be positioned further aft despite a consistent tip chord length at outboard edge 135 and a consistent apex distance 142 among wingtips 1600, 1610, and 1620.

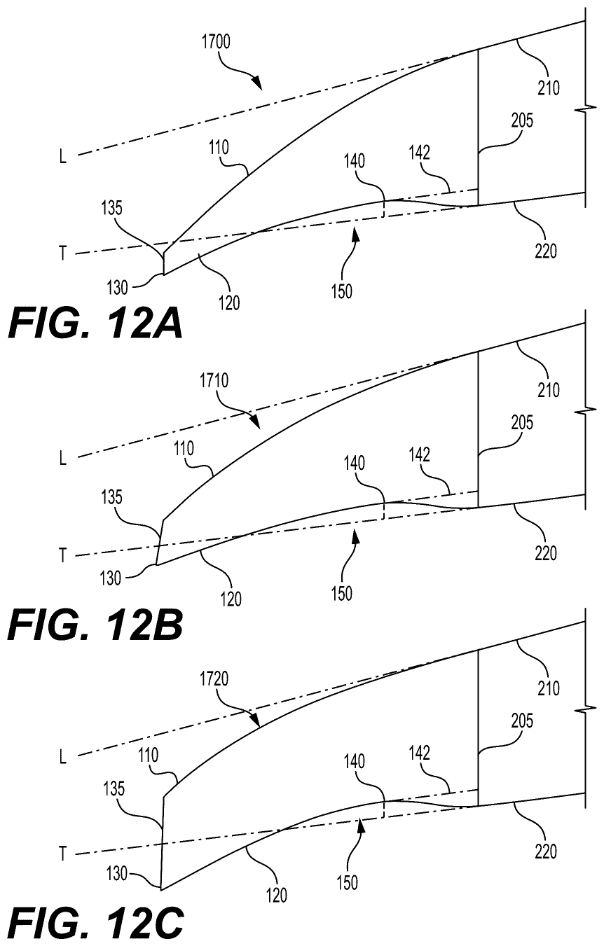

FIGS. 12A-12C show some non-limiting examples of wingtips having variations in tip chord length. For example, scythe wingtips 1700, 1710, and 1720 of FIGS. 12A, 12B, and 12C, respectively, each have different tip chord lengths at outboard edge 135. In different embodiments, the tip chord length at outboard edge 135 may range from zero (i.e., leading edge 110 extends directly to trailing edge 120 at tip 130) up to the wing chord length at interface 205. For example, as shown in FIG. 12A, a scythe wingtip 1700 has a small (but finite) tip chord length at outboard edge 135 in which the tip chord length is less than that of wingtips 1710 and 1720; as shown in FIG. 12B, a scythe wingtip 1710 has a medium tip chord length at outboard edge 135 in which the tip chord length is greater than that of scythe wingtip 1700 but less than that of a scythe wingtip 1720; and, as shown in FIG. 12C, scythe wingtip 1720 has a large tip chord length at outboard edge 135 in which the tip chord length is greater than that of scythe wingtips 1700 and 1710. Note that the tip chord length variations may affect the aft sweep of leading edge 110, the aft sweep of trailing edge 120, or both.

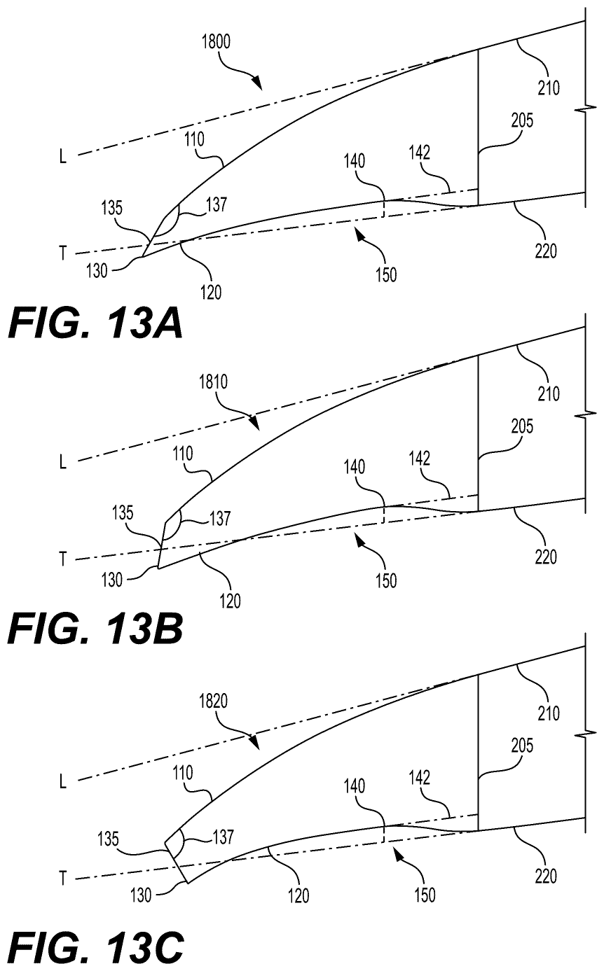

FIGS. 13A-13C show some non-limiting examples of wingtips having variations in tip outboard edge angle. For example, scythe wingtips 1800, 1810, and 1820 of FIGS. 13A, 13B, and 13C, respectively, have an outboard edge angle 137 between outboard edge 135 and leading edge 110 that varies despite the same sweep and curvature of leading edge 110. For example, as shown in FIG. 13A, a scythe wingtip 1800 has a large outboard edge angle 137 in which outboard edge 135 extends substantially outboard with respect to interface 205, thereby forming a substantially pointed tip 130 compared to that of wingtips 1810 and 1820; as shown in FIG. 13B, a scythe wingtip 1810 has a medium outboard edge angle 137 in which outboard edge 135 extends slightly outboard compared to that of wingtips 1800 and 1820; and, as shown in FIG. 13C, scythe wingtip 1820 has a small outboard edge angle 137 in which outboard edge 135 reverts substantially inboard with respect to interface 205. The outboard edge angle 137 of wingtip 1800 is approximately 150-degrees, angle 137 of wingtip 1810 is approximately 120-degrees, and angle 137 of wingtip 1820 is approximately 90-degrees. However, the depicted embodiments are exemplary only and other angles including greater than 150-degrees or less than 90-degrees may be employed without departing from the scope hereof. Note that the outboard edge angle 137 may affect the shape and aft sweep of trailing edge 120 despite the same length of outboard edge 135 in wingtips 1800, 1810, and 1820.

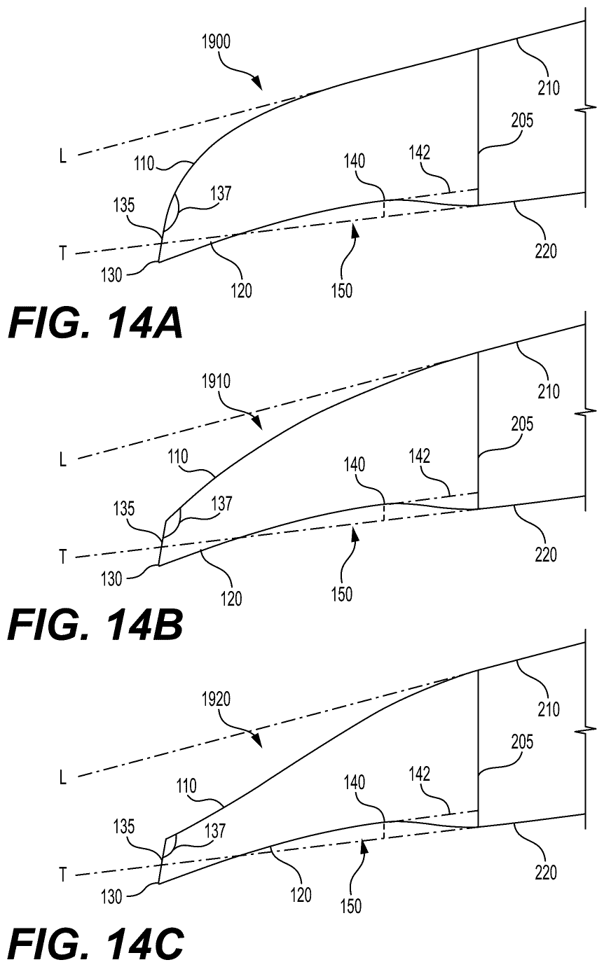

FIGS. 14A-14C show some non-limiting examples of wingtips having variations in the shape of leading edge 110. For example, the leading edge 110 of scythe wingtips 1900, 1910, and 1920 of FIGS. 14A, 14B, and 14C, respectively, have different curvatures. For example, as shown in FIG. 14A, leading edge 110 of a scythe wingtip 1900 extends from wing leading edge 210 along leading edge planform L past apex 140 (i.e., leading edge 110 extends along projected planform L a distance greater than apex distance 142), and leading edge 110 of wingtip 1900 curves aft to smoothly transition to outboard edge 135 compared to wingtips 1910 and 1920; as shown in FIG. 14B, leading edge 110 of a scythe wingtip 1910 sweeps aft of leading edge planform L between apex 140 and interface 205, and leading edge 110 of wingtip 1910 curves continuously aft and outboard to outboard edge 135 forming a sharper outboard edge angle 137 compared to that of wingtip 1900; and, as shown in FIG. 14C, leading edge 110 of a scythe wingtip 1920 sweeps aft of leading edge planform L between apex 140 and interface 205, and leading edge 110 of wingtip 1920 curves aft and outboard with an inflection point to outboard edge 135 forming a sharper outboard edge angle 137 compared to that of wingtips 1910 and 1900. Note how the variation in leading edge shape alters the overall planform size of the scythe wingtip, with wingtip 1900 having the largest planform and wingtip 1920 having the smallest planform despite outboard edge 135, apex 140, and apex distance 142 being the same among wingtips 1900, 1920, and 1920.

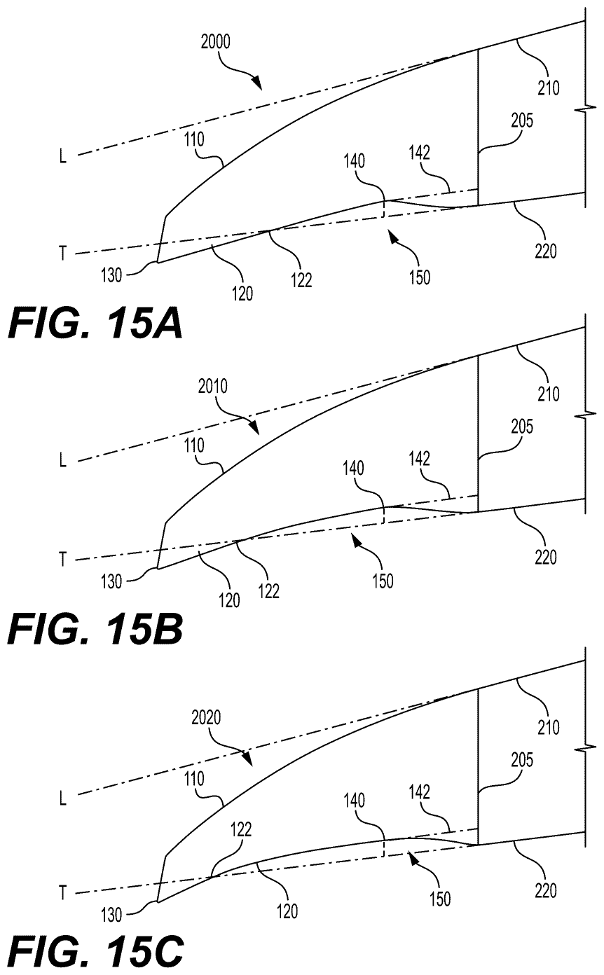

FIGS. 15A-15C show some non-limiting examples of wingtips having cutout shape variations. For example, the cutout 150 of scythe wingtips 2000, 2010, and 2020 of FIGS. 15A, 15B, and 15C, respectively, have differently shaped cutouts 150. Although apex 140 and apex distance 142 are the same among wingtips 2000, 2010, and 2020, the shape of trailing edge 120 is varied to provide varying cutout shapes. For wingtips 2000, 2010, and 2020, trailing edge 120 curves forward of projected planform T between interface 205 and apex 140, and trailing edge 120 curves aft between apex 140 and tip 130. For wingtip 2010, cutout 150 extends outboard further than for wingtip 2000 (i.e., intersection 122 is further outboard on wingtip 2010 than wingtip 2000); and, for wingtip 2020, cutout 150 extends outboard further than for both wingtips 2010 and 2020 (i.e., intersection 122 is further outboard on wingtip 2020 than wingtips 2010 and 2000).

Wingtip devices 100, 300, 400, 500, 600, 700, 800, winglets 900, 1000, and wingtip devices 1100, 1110, 1120, 1200, 1210, 1220, 1300, 1310, 1320, 1400, 1410, 1420, 1500, 1510, 1520, 1530, 1600, 1610, 1620, 1700, 1710, 1720, 1800, 1810, 1820, 1900, 1910, 1920, 2000, 2010, and 2020 each extend the effective span of wing 200 and therefore serve as extending members. Increased effective span reduces wing span-wise loading and, correspondingly, span-wise gradient of lift for a given total lift force. As taught by classical lifting-line theory, a reduction in spanwise downwash gradients and a corresponding reduction in induced drag is therefore provided. The forward sweep of trailing edge 120 forms cutout 150 which provides a reduction of wetted area that lowers the amount of viscous or skin-friction drag produced by the wingtip/winglet. The continuous chord and thickness distribution, including at interface 205, provides a continuous span-wise distribution of lift, which is important, as discontinuous “jumps” in span-wise lift result in the production of vortices that can increase both induced and interference drag. The continuous thickness distribution, in coordination with a reduced chord length due to cutout 150, results in a smaller projected frontal area, resulting in a reduction of form drag. The reduction of form drag and the continuous sweptback shape of leading edge 110 also reduce compressibility drag for use in the transonic flight regime. An additional reduction in induced drag may also be associated with lifting surfaces that are considerably aft-swept, such as the aft-swept tip 130 of the embodiments disclosed herein. The curved lifting lines of the presently disclosed embodiments may also contribute to additional reductions in induced drag. The continuous trailing edge 120, leading edge 110, chord, and thickness distributions at interface 205 provide a practical wingtip/winglet attachment for attaching to wing 200, including accommodation of structural components needed to provide appropriate load paths from the wingtip/winglet to the wing spars or other load carrying wing structural components.

In some embodiments, continuous reversals of slope of trailing edge 120 may be provided for installation of trailing edge lights, antennae, or fairing of fuel vent or jettison piping. Variations in trailing edge 120 may add to the total wetted area of the device, but not as much as a constant or progressively more swept trailing edge geometry as commonly seen in trapezoidal winglets. Trailing edge 220 is curved to remove sections of the scythe wingtips disclosed herein, which contribute minimally to pressure recovery, thereby enhancing the tradeoff between induced and profile (i.e., pressure, skin friction) drag. The disclosed geometries also increase options for incorporation of wingtip lighting by allowing light to extend through cutout 150.

Generally, embodiments disclosed herein may be useful for any wing-borne flight vehicle. Similar benefits on rotors or other wing-like components (such as aerodynamic stabilizing surfaces) may also be obtained, for example, on road-going vehicles.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A wingtip device, comprising:
a wingtip leading edge configured to extend continuously with aft sweep outboard from a wing leading edge; and
a wingtip trailing edge configured to extend continuously outboard of a wing trailing edge,
wherein the wingtip trailing edge comprises:
a smooth continuation of the wing trailing edge at an interface between the wing and the wingtip device; and
a cutout formed in the wingtip trailing edge, wherein the cutout extends outboard from the interface with forward sweep relative to the wing trailing edge.

2. The wingtip device of claim 1, comprising an apex in the cutout wherein a tangent slope of the apex is parallel to the wing trailing edge at the interface.

3. The wingtip device of claim 2, wherein the apex is located an apex distance outboard from the interface, and the apex distance exceeds a forward distance of the apex from a projected planform line of the wing trailing edge.

4. The wingtip device of claim 2, comprising a tip of the wingtip device wherein the wingtip leading edge and the wingtip trailing edge extend to the tip.

5. The wingtip device of claim 4, wherein the tip is located aft of the apex.

6. The wingtip device of claim 5, wherein the tip is located aft of a planform projection of the wing trailing edge.

7. The wingtip device of claim 6, wherein the tip comprises a pointed, sheared, or rounded shape.

8. A device for reducing wing drag, comprising:
an extending member that extends from an outboard interface of a wing to increase an effective span of the wing for reducing induced drag, wherein the extending member comprises a leading edge and a trailing edge that each extend with a smooth and continuous profile from a wing leading edge and a wing trailing edge at the interface, respectively,
wherein the trailing edge of the extending member curves forward of a planform projection of the wing trailing edge, thereby forming a reduction in wetted area of the extending member while maintaining a continuous profile with the wing trailing edge for reducing effects of skin-friction, form, interference, and compressibility drag.

9. The device of claim 8, comprising a tip at an outboard point of the extending member wherein the leading edge and trailing edge of the extending member extend to the tip.

10. The device of claim 9, wherein a span of the extending member comprises a distance from the interface to a most outboard point of the extending member, and wherein a distance from the tip to the interface is less than the span of the extending member.

11. The device of claim 8, wherein the trailing edge of the extending member comprises a combination of linear and curvilinear segments comprising a substantially smooth and continuous profile.

12. The device of claim 8, wherein the extending member is upturned relative to the wing and outboard of the interface and comprises an upward curvature.

13. The device of claim 8, wherein the extending member is downturned relative to the wing and outboard of the interface and comprises a downward curvature.

14. The device of claim 8, wherein the extending member is located in plane with the wing and comprises no upward nor downward curvature.

15. The device of claim 8, wherein the extending member comprises a substantially smooth and continuous spanwise thickness along its length.

16. The device of claim 15, comprising a portion of narrowing spanwise thickness of the extending member outboard from the interface.

17. A winglet, comprising:
an interface between a wing and the winglet wherein the interface comprises one seamless structure;
a winglet leading edge comprising a smooth and continuous profile at the interface with a wing leading edge;
a winglet trailing edge comprising a smooth and continuous profile at the interface with a wing trailing edge;
a tip configured aft of the trailing edge of the wing; and
a cutout configured in the trailing edge of the winglet comprising an apex forward of a planform projection of the wing trailing edge, wherein the cutout reduces a wetted area of the winglet for reducing effects of skin-friction, form, interference, and compressibility drag.

18. The winglet of claim 17, comprising a portion of the winglet that is outboard of the cutout that sweeps aft of a planform projection of the wing trailing edge.

19. The winglet of claim 17, comprising an outboard edge connecting the tip to the winglet leading edge.

20. The winglet of claim 19, wherein the winglet leading edge and the outboard edge meet at an angle such that the tip outboard edge is not smooth with the profile of the winglet leading edge.
